(19) United States
(12) Patent Application Publication
(10) Pub. No.: US 2014/0374038 A1
(43) Pub. Date: Dec. 25, 2014

(54) POSITIONING DEVICE OF WINDOW COVERING

(71) Applicant: NIEN MADE ENTERPRISE CO., LTD., Taichung City (TW)

(72) Inventor: Lin CHEN, Taichung City (TW)

(73) Assignee: NIEN MADE ENTERPRISE CO., LTD., Taichung City (TW)

(21) Appl. No.: 14/287,566

(22) Filed: May 27, 2014

(30) Foreign Application Priority Data
Jun. 21, 2013 (CN) 201320358114.4

(51) Int. Cl. E06B 9/324; E06B 9/325; E06B 9/388

(52) U.S. Cl. CPC E06B 9/324; E06B 9/388; E06B 9/325
USPC 160/370

(57) ABSTRACT

A positioning device for a window covering includes a base, two clamping members, and an operating member. The base has a main recess and a cord bore, and the cord bore is communicated with main recess, and a cord is inserted into the cord bore and passes through the main recess. The clamping members are movably received in the main recess of the base, and the cord passes through a space between the clamping members. The operating member is connected to the base for rotation to drive the clamping members to move. While the operating member is turned, the clamping members will be moved toward each other to clamp the cord.

The current application claims a foreign priority to the patent application of China No. 201320358114.4 filed on Jun. 21, 2013.

### BACKGROUND OF THE INVENTION

1. Field of the Invention

The present invention relates generally to a window covering, and more particularly to a positioning device of a cordless window covering or a cellular shade.

2. Description of the Related Art

A conventional cordless window covering includes two rails and a valance with opposite ends connected to the rails. Two cords are provided to connect the rails to change vertical positions of the rails respectively, and therefore the valance is folded or unfolded.

In order to fasten the rails to the cords while they are moved to the desired vertical positions, a conventional way is providing two bores on each rail for the cords to pass through. These bores are not aligned with bores on the rails, through which the cords pass, so that the cords will be rested against sidewalls of the bores to generate frictions. The frictions are proportional to a weight of the valance. The frictions may hold the rails on the cords. It is easy to under that the structure and the strength of the rail would be worn out fast because of the bores and the pressures of the cords. An improved design is to provide two cord clamping devices on the rail to connect the cords. The cord clamping device can slow the wear out of the rails, however, the problem of cord wearing still exists. The worn cords will have difficulty to hold the rails.

### SUMMARY OF THE INVENTION

The primary objective of the present invention is to provide a positioning device of a window covering, which holds the rail at any desired vertical position without the aforesaid drawbacks.

According to the objective of the present invention, a positioning device for a window covering includes a base, a first clamping member, a second clamping member, and an operating member. The base is connected to the rail of the window covering, and has a main recess and a cord bore, wherein the cord bore is communicated with main recess, and the cord is inserted into the cord bore and passes through the main recess. The first clamping member is movably received in the main recess of the base, and having a first driven cam portion. The second clamping member is received in the main recess of the base, wherein the cord passes through a space between the first clamping member and the second clamping member. The operating member is connected to the base for rotation, and has a first guiding post received in the main recess of the base, wherein the first guiding post has a first driving cam portion resting against the first driven cam portion of the first clamping member. The first clamping member is moved toward the second clamping member to clamp the cord while the operating member is turned.

In an embodiment, the base has a main board and two clamping boards at a top end and a bottom end of the main board respectively; the main board has the main recess and a guiding slot on the main recess; the operating member is connected to a side of the main board opposite to the main recess, and the first guiding post is inserted into the guiding slot and enters the main recess; the cord bore extends from the top end to the bottom end of the main board.

In an embodiment, the main board is provided with an annular wall at the side opposite to the main recess; the annular wall is provided with a plurality of locking slots at an inner side thereof; the operating member has an inner ring, on which a protrusion is provided; the protrusion engages one of the locking slots while the operating member is turned.

In an embodiment, the main board further has a bore on one side of the main recess; the first clamping member has a first post received the bore; the first guiding slot is a curved slot, and the first driven cam portion is a curved surface corresponding to the first guiding slot.

In an embodiment, the main board is provided with an annular wall at the side opposite to the main recess; the annular wall is provided with a protrusion at an outer side thereof; the operating member has a plurality of locking slots to engage the protrusion while the operating member is turned.

In an embodiment, the second clamping member is movably received in the main recess of the operating member, and has a second driven cam portion; the operating member is provided with a second guiding post received in the main recess of the operating member; the second guiding post is provided with a second driving cam portion resting against the second driven cam portion of the second clamping member; the second clamping member is moved toward the first clamping member to clamp the cord while the operating member is turned.

Therefore, the clamping members would clamp the cord by turning the operating member to hold the rail at the current position.

### BRIEF DESCRIPTION OF THE DRAWINGS

FIG. 1 is a perspective view of the window covering with a first preferred embodiment of the present invention;

FIG. 2 is a perspective view of the positioning device of the first preferred embodiment of the present invention;

FIG. 3 is an exploded view of the positioning device of the first preferred embodiment of the present invention;

FIG. 4 is another exploded view of the positioning device;

FIG. 5 is a front view of the base of the positioning device of the first preferred embodiment of the present invention;

FIG. 6 is a sectional view of the positioning device of the first preferred embodiment of the present invention, showing the clamping members releasing the cord;

FIG. 7 is a sectional view of the positioning device of the first preferred embodiment of the present invention, showing the clamping members clamping the cord;

FIG. 8 is an exploded view of the positioning device of a second preferred embodiment of the present invention;

FIG. 9 is another exploded view of the positioning device; and

FIG. 10 is a sectional view of the positioning device of the second preferred embodiment of the present invention, showing the clamping members releasing the cord.

### DETAILED DESCRIPTION OF THE INVENTION

The detailed description and technical contents of the present invention will be explained with reference to the accompanying drawings. However, the drawings are illustrative only but shall not be used to limit the present invention.

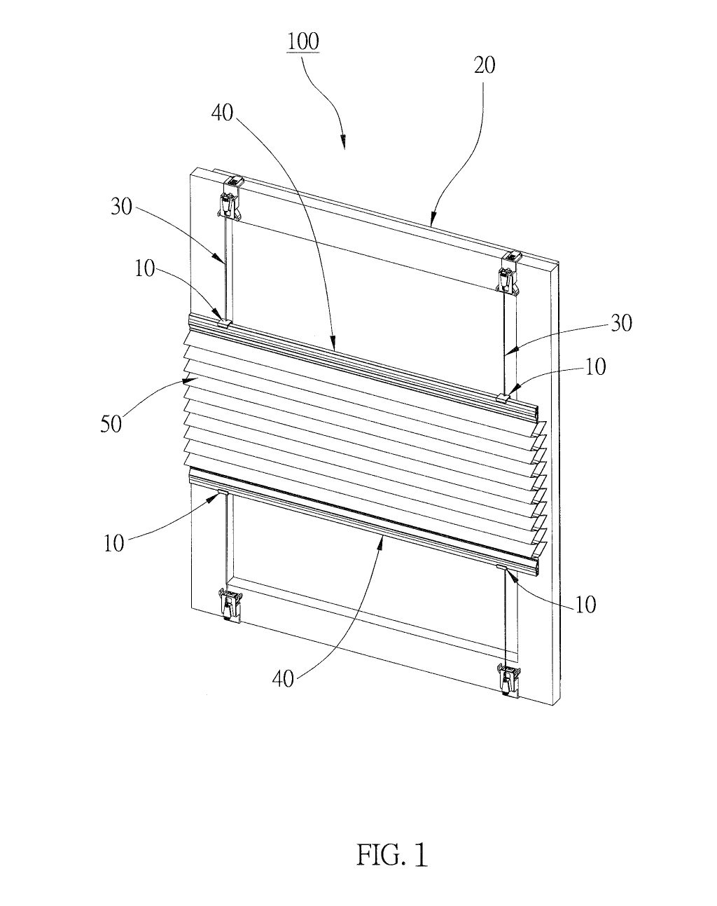

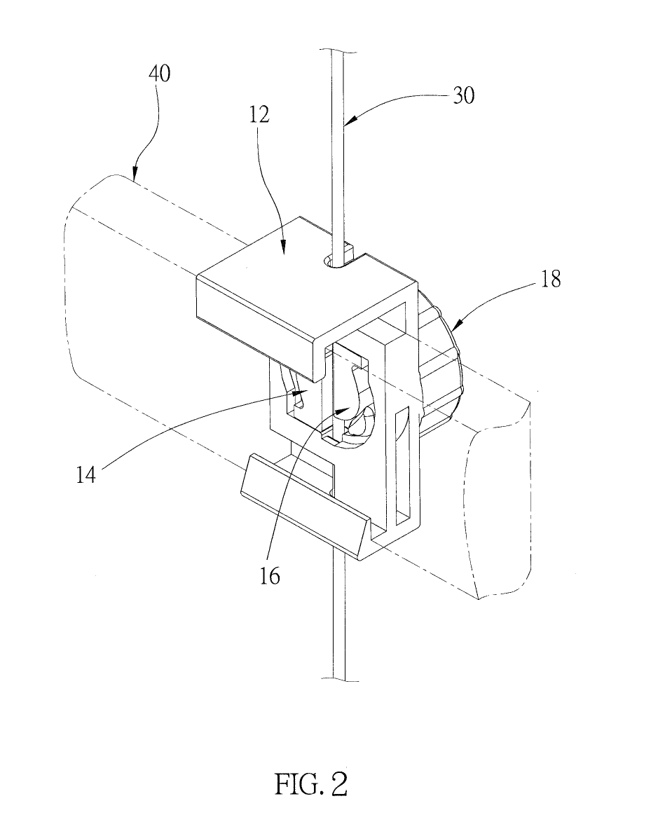

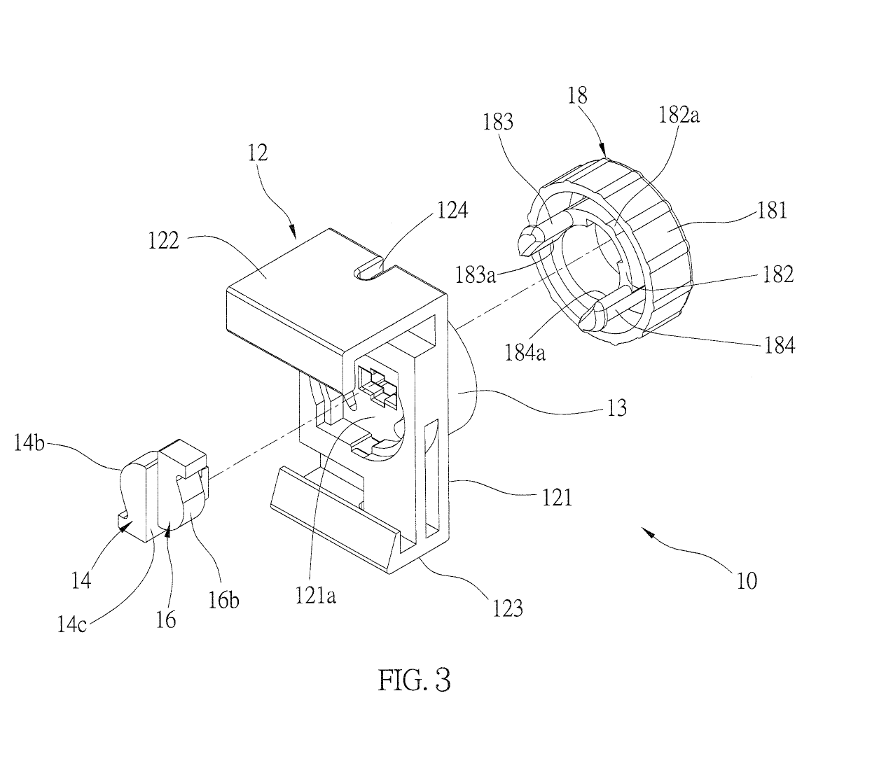

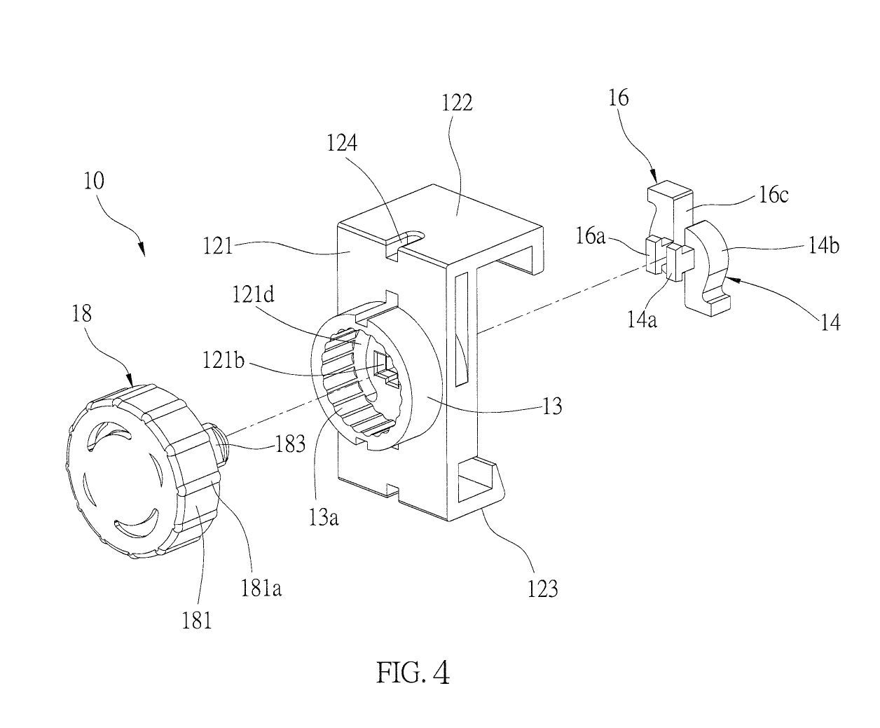

FIG. 1 shows a window covering 100 of the first preferred embodiment of the present invention, which includes a frame 20, two cords 30 with opposite ends connected to the frame 20, two rails 40, through which the cords 30 pass, two positioning device 10, and a valance 50. The valance 50 is shown as a honeycomb shades in the figures. As shown in FIG. 2 to FIG. 4, each positioning device 10 includes a base 12, a first clamping member 14, a second clamping member 16, and an operating member 18.

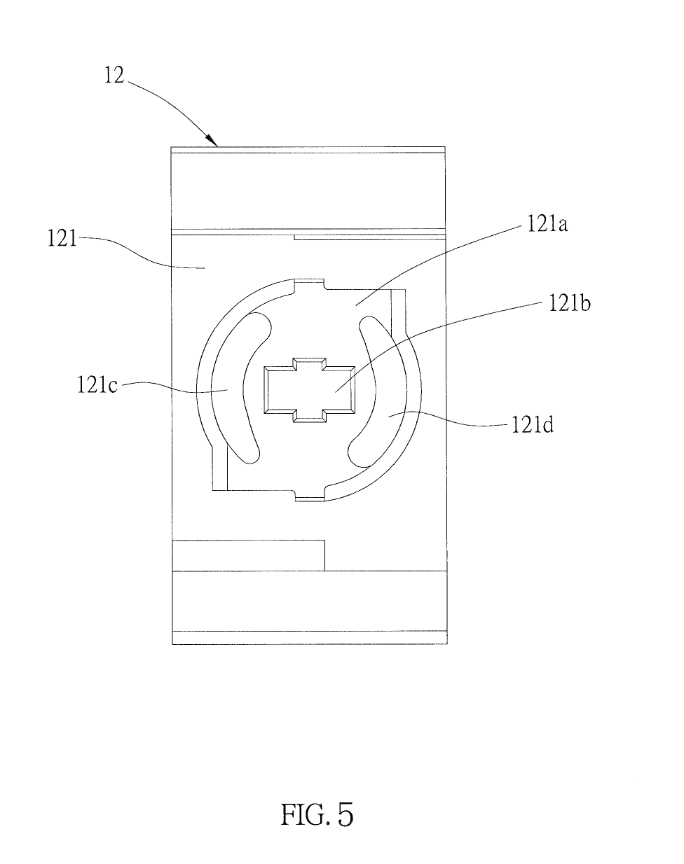

The base 12 has a main board 121 and two clamping boards 122, 123. As shown in FIG. 5, the main board 121 is provided with a main recess 121a, a bore 121b, a first guiding slot 121c, and a second guiding slot 121d. The main recess 121a is provided on a side of the main board 121, the bore 121b is a cross through hole on a center of the main recess 121a, the first and the second guiding slots 121c and 121d are two symmetrical curved slots on the main recess 121a, and the bore 121b is between the first and the second guiding slots 121c and 121d.

The clamping boards 122 and 123 have ends connected to a top end and a bottom end of the main board 121 respectively, and are vertical to the main board 121. At a distal end of each clamping board 122 a hook is provided which allows the base 12 to be connected with the rail 40. The main board 121 is provided with a cord bore 124 extending from the top end to the bottom end. The cord bore 124 is communicated with the main recess 121a. The cord 30 is inserted into the cord bore 124, and passes through the main recess 121a. The main board 121 is provided with an annular wall 13 on a side opposite to the main recess 121a, and the bore 121b is within the annular wall 13. The annular wall 13 is provided with a plurality of locking slots 13a at an inner side thereof, and the locking slots 13a are parallel to each other and open at a distal end of the annular wall 13.

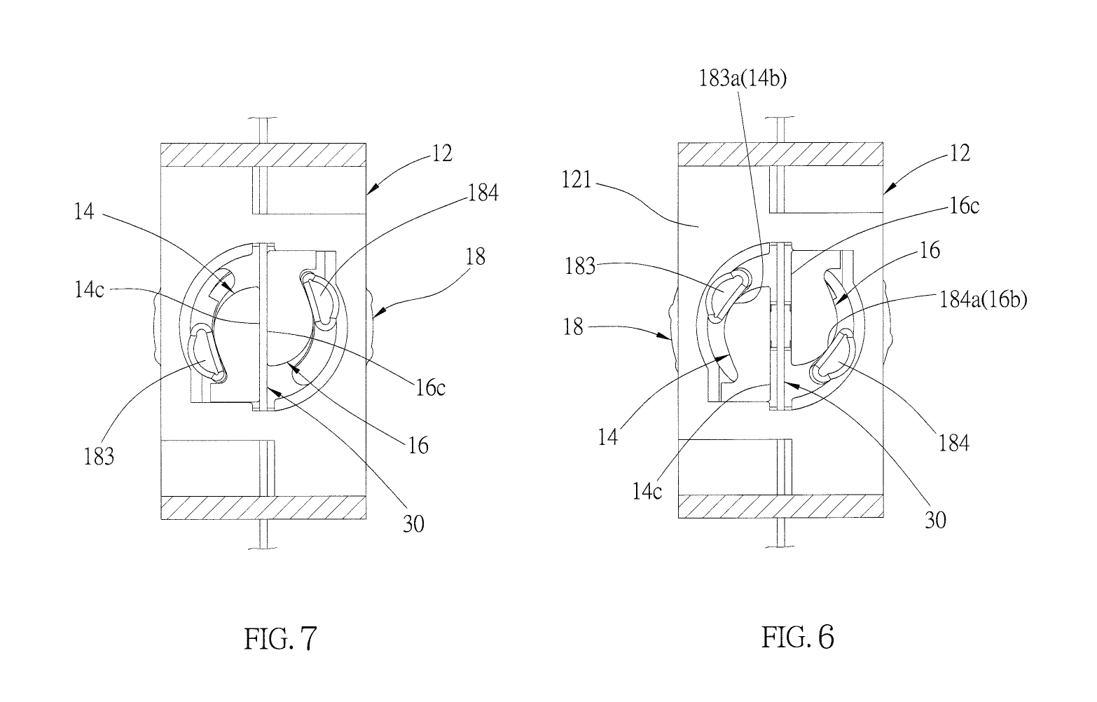

The first clamping member 14 and the second clamp member 16 are the same in the present embodiment. The first clamping member 14 has a T-shaped first post 14a, and the second clamp member 16 has a T-shaped second post 16a, and both the posts 14a, 16b are received in the bore 121b to engage the first clamping member 14 and the second clamp member 16 with the base 12 and allow them to move in the bore 121b. The rest parts of the first clamping member 14 and the second clamp member 16 are received in the main recess 121a. The first clamping member 14 has a first driven cam portion 14b and a first clamping portion 14c, and the second clamp member 16 has a second driven cam portion 16b and a second clamping portion 16c, wherein the driven cam portions 14b, 16b are two curved surfaces corresponding to the guiding slots 121c and 121d respectively, and the clamping portions 14c, 16c are two flat surfaces facing each other. As shown in FIG. 6, the cord 30 passes through a space between the clamping portions 14c, 16c of the clamping members 14, 16.

The operating member 18 includes a knob 181, an inner ring 182, a first guiding post 183, and a second guiding post 184. The knob 181 has a disk and an outer ring on an edge of the disk, and the outer ring has teeth 181a to increase friction while the user holds and turns the knob 181. The inner ring 182 is distanced from an inner side of the knob 181, and parallel to the outer ring. The inner ring 182 has a protrusion 182a on an outer side thereof, and the protrusion 182a faces the outer ring. The first guiding post 183 and the second guiding post 184 are projected from a distal end of the inner ring 182.

The first guiding post 183 and the second guiding post 184 are inserted into the first guiding slot 121c and the second guiding slot 121d of the base 12 respectively, and distal ends of the first guiding post 183 and the second guiding post 184 enter the main recess 121a. The first clamping member 14 and the second clamp member 16 are between the first guiding post 183 and the second guiding post 184. The first guiding post 183 has a first driving cam portion 183a resting against the first driven cam portion 14b of the first clamping member 14, and the second guiding post 184 has a second driving cam portion 184a resting against the second driven cam portion 16b of the second clamping member 16.

The inner ring 182 of the operating member 18 is received within the annular wall 13, and the protrusion 182a engages one of the locking slots 13a while the knob 181 is turned by user to hold the operating member 18 at a certain position.

As shown in FIG. 6, while the operating member 18 is turned to move the guiding posts 183, 184 to one ends of the driven cam portions 14b, 16b of the clamping members 14, 16 respectively, a width of the space between the clamping portions 14c, 16c is big, and the cord 30 is not clamped by the clamping members 14, 16. As shown in FIG. 7, while the operating member 18 is turned to move the first guiding posts 183, 184 toward middles of the driven cam portions 14b, 16b respectively, the first clamping member 14 and the second driven cam portion 16b will be moved toward each other, and the clamping portions 14a, 16a of the clamping members 14, 16 press the cord 30 to clamp the cord 30. While the first guiding post 183 and the second guiding post 184 arrive at the middles of the driven cam portions 14b, 16b (the highest portions), the clamping force of the clamping members 14, 16 would be the largest. In other words, the clamping force on the cord 30 would be adjusted by turning the operating member 18. With the engagement of the protrusion 182a and the locking slot 13a, it may maintain the first guiding post 183 and the second guiding post 184 at the present positions even when the cord 30 is pulled.

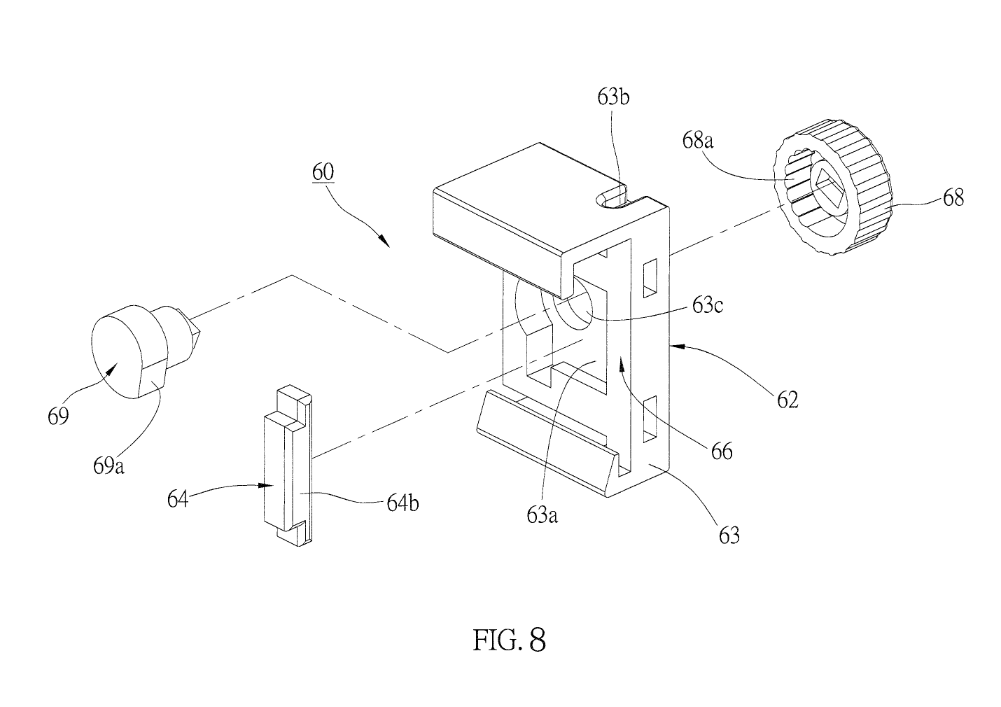

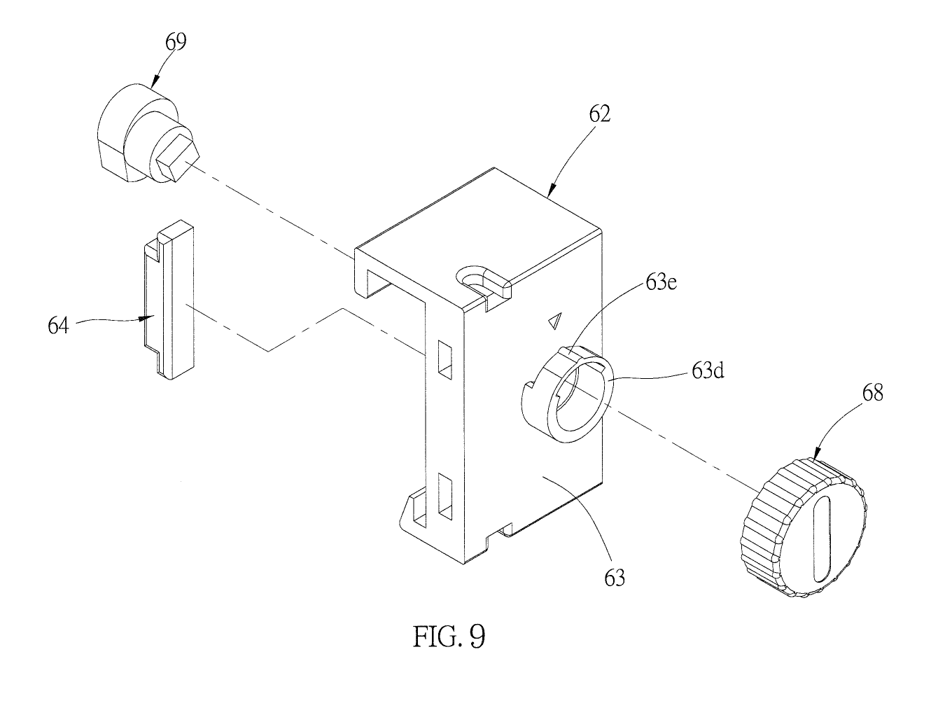

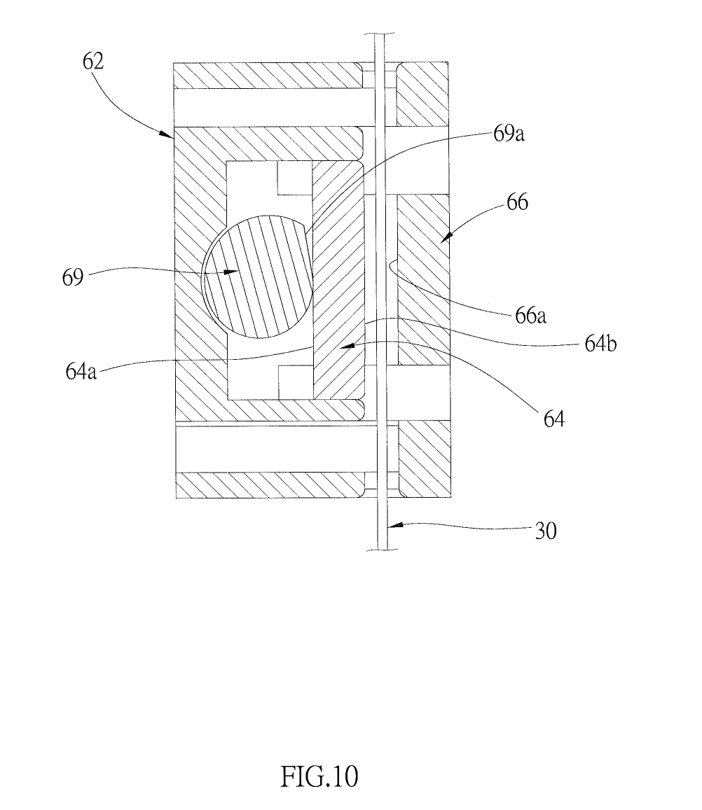

As shown in FIG. 8 to FIG. 10, a positioning device 60 of the second preferred embodiment of the present invention includes a base 62, a first clamping member 64, a second clamping member 66, and an operating member. The base 62 has a main board 63, on which a main recess 63a, a cord bore 63b, and a first guiding slot 63c are provided. The cord bore 63b extends from a top end and a bottom end of the main board 63, and is communicated with the main recess 63a. The first guiding slot 63c is on the main recess 63a, and is open at opposite sides of the main board 63. The first clamping member 64 is received in the main recess 63a for reciprocation, and has a first driven cam portion 64a and a first clamping portion 64b. In the present embodiment, the second clamping member 66 is a part of the main board 63, in other words, it is fixed. The second clamping member 66 has a second clamping portion 66a facing the first clamping portion 64b. The cord 30 is inserted into the cord bore 63b and passes through a space between the clamping portions 64b, 66a of the clamping members 64, 66. The operating member has a knob 68 and a first guiding post 69. The first guiding post 69 is inserted into the first guiding slot 63c, and has a first driving cam portion 69a. The first driving cam portion 69a rests against the first driven cam portion 64a of the first clamping member 64 to move the first clamping member 64 while the knob 68 is turned. In the present embodiment, the first driving cam portion 69a is a circumference with a flat section, and while the knob 68 is turned to have the flat section facing the first driven cam portion 64a, it makes the first clamping member 64 no longer press the cord 30 to release the cord 30. On the contrary, while the knob 68 is turned to have the rest part of the first driving cam portion 69a facing the first driven cam portion 64a, it makes the first clamping member 64 press the cord 30 to clamp the cord 30. The main board 63 is provided with an annular wall 63d at a side opposite to the main recess 63a, and the first guiding slot 63c is within the annular wall 63d. The annular wall 63d is provided with a protrusion 63e on an outer side thereof, and the knob 68 is provided with locking slots 68a on an inner side thereof. The protrusion 63e engages one of the locking slots 68a while the knob 68 is turned to temporarily hold knob 68.

The description above is only a few preferred embodiments of the present invention and the equivalence of the present invention is still in the scope of claim construction of the present invention.

What is claimed is:

1. A positioning device for a window covering, wherein the window covering has a rail and a cord, comprising:
a base, which is connected to the rail of the window covering, having a main recess and a cord bore, wherein the cord bore is communicated with main recess, and the cord is inserted into the cord bore and passes through the main recess;
a first clamping member movably received in the main recess of the base, and having a first driven cam portion;
a second clamping member received in the main recess of the base, wherein the cord passes through a space between the first clamping member and the second clamping member; and
an operating member connected to the base for rotation, and having a first guiding post received in the main recess of the base, wherein the first guiding post has a first driving cam portion resting against the first driven cam portion of the first clamping member;
wherein the first clamping member is moved toward the second clamping member to clamp the cord while the operating member is turned.

2. The positioning device as defined in claim 1, wherein the base has a main board and two clamping boards at a top end and a bottom end of the main board respectively; the main board has the main recess and a guiding slot on the main recess; the operating member is connected to a side of the main board opposite to the main recess, and the first guiding post is inserted into the guiding slot and enters the main recess; the cord bore extends from the top end to the bottom end of the main board.

3. The positioning device as defined in claim 2, wherein the main board is provided with an annular wall at the side opposite to the main recess; the annular wall is provided with a plurality of locking slots at an inner side thereof; the operating member has an inner ring, on which a protrusion is provided; the protrusion engages one of the locking slots while the operating member is turned.

4. The positioning device as defined in claim 3, wherein the main board further has a bore on the main recess; the first clamping member has a first post received in the bore; the first guiding slot is a curved slot, and the first driven cam portion is a curved surface corresponding to the first guiding slot.

5. The positioning device as defined in claim 2, wherein the main board is provided with an annular wall at the side opposite to the main recess; the annular wall is provided with a protrusion at an outer side thereof; the operating member has a plurality of locking slots to engage the protrusion while the operating member is turned.

6. The positioning device as defined in claim 1, wherein the second clamping member is movably received in the main recess of the operating member, and has a second driven cam portion; the operating member is provided with a second guiding post received in the main recess of the operating member; the second guiding post is provided with a second driving cam portion resting against the second driven cam portion of the second clamping member; the second clamping member is moved toward the first clamping member and the first clamping member is moved toward the second clamping member to clamp the cord while the operating member is turned.
